(19) United States
(12) Patent Application Publication
(10) Pub. No.: US 2006/0037501 A1
(43) Pub. Date: Feb. 23, 2006

(54) Image forming apparatus capable of effectively reducing color displacement

(76) Inventor: Fumihito Masubuchi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/205,155

(22) Filed: Aug. 17, 2005

(30) Foreign Application Priority Data
Aug. 19, 2004 (JP) 2004-239140
Jun. 14, 2005 (JP) 2005-173175

(51) Int. Cl. B41F 5/18

(52) U.S. Cl. 101/179

(57) ABSTRACT

An image forming apparatus capable of effectively reducing a color displacement among a plurality of tandem image carrying drums includes a transfer belt, first and second image carrying drums, first and second drum gears, a motor gear, and an idle gear. A station pitch between rotation axes of the first and second drum gears is different from a value of a multiplication of a circumference of the first and second image carrying drums by a factor of an arbitrary positive integer. An eccentric amplitude rate between a first eccentric amplitude that a pitch circle of the first drum gear has and a second eccentric amplitude that a pitch circle of the second drum gear has is optionally selected in accordance with factors including the station pitch, design values of the idle gear and the circumference of the first and second image carrying drums.

### BACKGROUND OF THE INVENTION

1. Field of the Invention

The present invention relates to an image forming apparatus, and more particularly to an image forming apparatus capable of effectively reducing a color displacement among a plurality of images in elementary colors0.

2. Discussion of the Background

A color image forming apparatus provided with a plurality of photoconductor drums arranged in line together with associated image forming mechanisms is referred to as a tandem type image forming apparatus. One example method for driving the plurality of photoconductor drums is called an idle gear driving method. In this method, the plurality of photoconductor drums are driven in such a way that a rotary drive force for one drive gear is transmitted to other drum gears via respective idle gears.

In such an idle gear driving method, however, variations in rotation caused mainly due to an eccentricity of the drum gear of each photoconductor drum are likely to become serious, particularly at the photoconductor drum which is driven via an idle gear. In order to reduce such a rotary variation or color displacements, phases of eccentricities associated with the drum gears are optically adjusted among the plurality of photoconductor drums.

One example technique focuses on a case in which a revolution speed of an idle gear is varied due to an eccentricity of the idle gear and a variation cycle of the revolution speed of the idle gear is different from that of the drum gear. This technique attempts to eliminate an effect of the speed variation cycle of the idle gear on a color displacement so that phases of eccentricities associated with drum gears would easily be adjusted among a plurality of photoconductor drums. In this technique, a distance between axes of two adjacent drum gears is assumed as not equal to an integral multiple value of a circumferential length. Therefore, values obtained through a simulation are used as a optimal phase difference of eccentricity between two adjacent drums to prevent color displacements between drums.

Color displacement, however, is generally more susceptible to an eccentric amplitude ratio between two drum gear lined next to each other with an idle gear therebetween than to a phase difference of eccentricity between two adjacent drums which the above-described technique focuses on.

### SUMMARY OF THE INVENTION

This patent specification describes a novel image forming apparatus capable of effectively reducing a color displacement among a plurality of tandem image carrying drums. In one example, a novel image forming apparatus includes a transfer belt, first and second image carrying drums, first and second drum gears, a motor gear, and an idle gear. The first image carrying drum is arranged in contact with the transfer belt. The second image carrying drum has dimensions in substantially common with the first image carrying drum and is arranged in contact with the transfer belt. The first drum gear is attached to the first image carrying drum. The second drum gear has dimensions in substantially common with the first image carrying drum and is attached to the second image carrying drum. The motor gear is configured to rotate the first drum gear. The idle gear is configured to transmit a driving power from the first drum gear to the second drum gear. In this structure, a station pitch between rotation axes of the first and second drum gears is different from a value of a multiplication of a circumference of the first and second image carrying drums by a factor of an arbitrary positive integer. In addition, an eccentric amplitude rate between a first eccentric amplitude that a pitch circle of the first drum gear has and a second eccentric amplitude that a pitch circle of the second drum gear has is optionally selected, during a process of assembling to the apparatus, in accordance with factors including the station pitch, a design value of the circumference of the first and second image carrying drums, and a design value of the idle gear to satisfy a plurality of predetermined conditions.

The plurality of predetermined conditions may include the following equations.
A_{2BEST}=·( (cos Φ₂−A₁₂ cos φ₁₂)²+(sin Φ₂−A₁₂ sin φ₁₂)²)
A₁₂=√( (1+cos(θ₁+π) )²+(1+sin(θ₁+π) )²)
φ₁₂=(θ₁−π)/2
Φ₂=2 (L−πD)/D

In these equations, A_{2BEST} is an eccentric angle of eccentricity of the second drum gear, A₁₂ is an eccentric amplitude of a transmissive eccentricity of the second drum gear, θ₁ is a first pinching angle of the second drum gear, φ₁₂ is an eccentric-phase difference between an eccentricity of the first drum gear and the transmissive eccentricity, Φ₂ is an optimal eccentric-phase difference between the eccentric angles of the first and second drum gears, L is the station pitch, and D is the diameter of the first and second image carrying drums.

The eccentric amplitude that the second pitch circle of the second drum gear has may be greater than the eccentric amplitude that the first pitch circle of the first drum gear has when a first pinching angle for pinching the first drum gear with the motor gear and the idle gear is substantially equal to 180 degrees.

The eccentric amplitude that the second pitch circle of the second drum gear has may be greater than the eccentric amplitude that the first pitch circle of the first drum gear has when a first pinching angle for pinching the first drum gear with the motor gear and the idle gear is smaller than 180 degrees and when the station pitch between rotation axes of the first and second drum gears satisfies an inequality πD*(n−0.5)<L<πD*n. In this inequality, π is 180 degree, n is a natural number, L is the station pitch, and D is the diameter of the first and second image carrying drums.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an image forming apparatus according to an embodiment of the present invention;

FIG. 2 is a schematic diagram of a major portion of the image forming unit of FIG. 1;

FIG. 3 is a schematic diagram of an example single reduction gear system associated with two example photosensitive drums of the image forming unit of FIG. 1;

FIGS. 4 and 5 are schematic diagrams of a part of the signal reduction gear system of FIG. 3 for explaining eccentricity;

FIG. 6 is a schematic diagram of another example single reduction gear system associated with two example photosensitive drums of the image forming unit of FIG. 1;

FIG. 7 is a schematic diagram of the example single reduction gear system of FIG. 3 for explaining an eccentric-phase difference and an optimal eccentric amplitude rate of the two drum gears;

FIGS. 8A-8D are graphs for explaining results of an example experiment associated with the eccentric-phase difference and the optimal eccentric amplitude rate of the two drum gears; and

FIGS. 9A-9D are graphs for explaining results of another example experiment associated with the eccentric-phase difference and the optimal eccentric amplitude rate of the two drum gears.

### DETAILED DESCRIPTION OF PREFERRED EMBODIMENTS

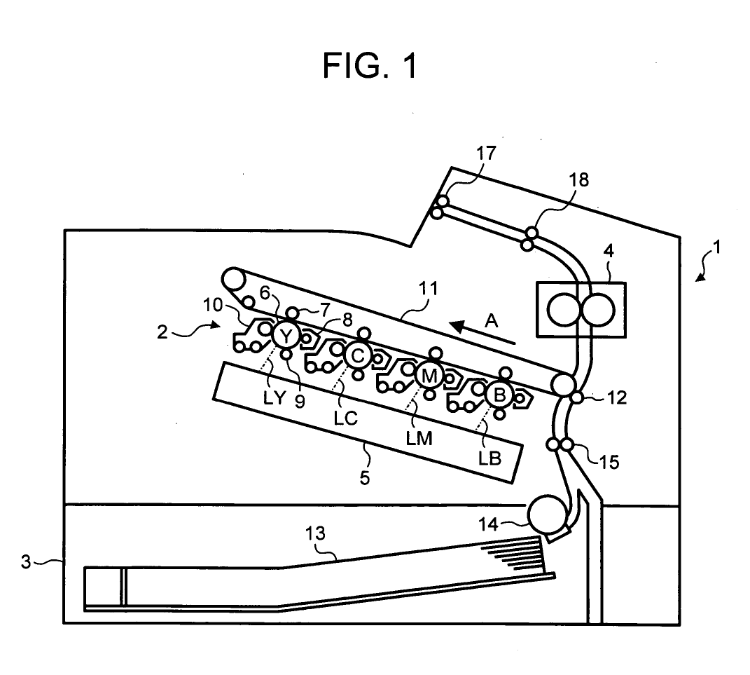

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a color image forming apparatus according to a preferred embodiment of the present invention is explained. FIG. 1 illustrates a color laser printer 1 as one example of the color image forming apparatus that employs a photoelectric image forming process. As illustrated in FIG. 1, the color laser printer 1 includes an image forming unit 2, a recording sheet storage unit 3, a fixing unit 4, an exposure unit 5, an intermediate transfer belt 11, and a secondary transfer unit 12. The color laser printer 1 further includes a sheet cassette 13, a pickup roller 14, feed roller pairs 15 and 16, and a sheet ejection roller pair 17.

The image forming unit 2 includes four image forming sections for forming images with toner in colors of yellow (Y), cyan (C), magenta (M), and black (B), as indicated by letters of Y, C, M and B. The four image forming sections are equivalent to each other in structure and component parts but are different from each other in colors of toner to use. The component parts of each one of the four image forming sections include a photosensitive drum 6, a primary transfer unit 7, a cleaning unit 8, a charging unit 9, and a development unit 10. The photosensitive drums 6 is centered and is surrounded by the primary transfer unit 7, the cleaning unit 8, the charging unit 9, and the development unit 10. The photosensitive drum 6 serves as an image carrying member to carry an image thereon.

The charging unit 9 includes a conductive roller (not shown) applied with a charging bias voltage from a power supply unit (not shown) to uniformly charge a photosensitive surface of the photosensitive drum 6. The exposure unit 5 irradiates the uniformly charged photosensitive surface of the photosensitive drum 6 with laser light LY, LC, LM, LB, which turns on and off based on image data, to form an electrostatic latent image on the photosensitive drum 6. The developing unit 10 develops the electrostatic latent image on the photosensitive drum 6.

As described above, the color laser printer 1 has four image forming sections for forming images with yellow, cyan, magenta, and black color toners, so as many of color image forming apparatuses have. However, since a full color image can be formed even with three color toners of yellow, cyan, and magenta without using the black color toner, a color image forming apparatus may be designed without the components associated with the black color toner.

The primary transfer unit 7 is disposed at a position to face the intermediate transfer belt 11 on a back surface of the intermediate transfer unit 11, and is configured to receive an application of a predetermined bias voltage. The primary transfer unit 7 is further configured to transfer a color toner image, carried on the photosensitive drum 6, from the photosensitive drum 6 to the intermediate transfer belt 11.

The intermediate transfer belt 11 is configured to rotate in a direction indicated by an arrow A in FIG. 1. A toner image formed on each one of the four photosensitive drums 6 comes in contact with the intermediate transfer belt 11, and is transferred onto the intermediate transfer belt 11 by an application of a predetermined bias voltage to the associated primary transfer roller 7.

The cleaning unit 8 removes the color toners remaining on the photosensitive drum 6 after the transfer process before the next image forming operation is started.

There are two major image transfer methods for an electrophotographic image forming apparatus using a tandem four photosensitive drums. In one method referred to as an intermediate transfer method, toner images in different basic colors formed by the photosensitive drums are sequentially transferred and superimposed into one image on the intermediate transfer belt 11. The image transfer in this process is referred to as a primary transfer. The thus-superimposed image is a color image and is transferred on a recording sheet, which transfer is referred to as a secondary transfer. The other method is referred to as a direct transfer method in which color toner images formed on the four photosensitive drums are sequentially transferred and superimposed into one image onto a recording sheet. The color laser printer 1 of FIG. 1 employs the former method. However, it is also possible to apply the present invention to an image forming apparatus employing the above latter transfer method.

In the color laser printer 1 using the above-described intermediate transfer method, images superimposed on the intermediate transfer belt 11 are collectively transferred to a recording sheet by the secondary transfer roller 1. In many cases, the recording sheet is a sheet of paper, and is stored in the sheet cassette 13 of the sheet storage unit 3. An uppermost recording sheet in the recording sheets is separated from others and is taken out by the pickup roller 14. In this way, the transfer sheets laying in the sheet cassette 13 are separated and fed out one by one into a sheet convey path by the pickup roller 13, and the thus-separated recording sheet is conveyed along the sheet convey path to the secondary transfer unit 12 by the feed roller pair 15. Then, a full color toner image formed by superimposing the four basic color toner images on the intermediate transfer belt 11 is transferred to the recording sheet conveyed by the sheet roller pair 15. Subsequently, for fixing the image, the transfer sheet is further conveyed along the sheet convey path to the fixing unit 4 which applies the recording sheet with heat and pressure to fix the image on the recording sheet. Then, the recording sheet with the image fixed thereon is transferred towards the sheet ejection roller pair 17 via the feed roller pair 16 and is discharged to outside of the color laser printer 1 by the sheet ejection roller pair 17.

It should be noted that the recording sheet serves as a moving element in the direct transfer, while the intermediate transfer belt 11 serves as a moving element in the indirect transfer or the intermediate transfer method.

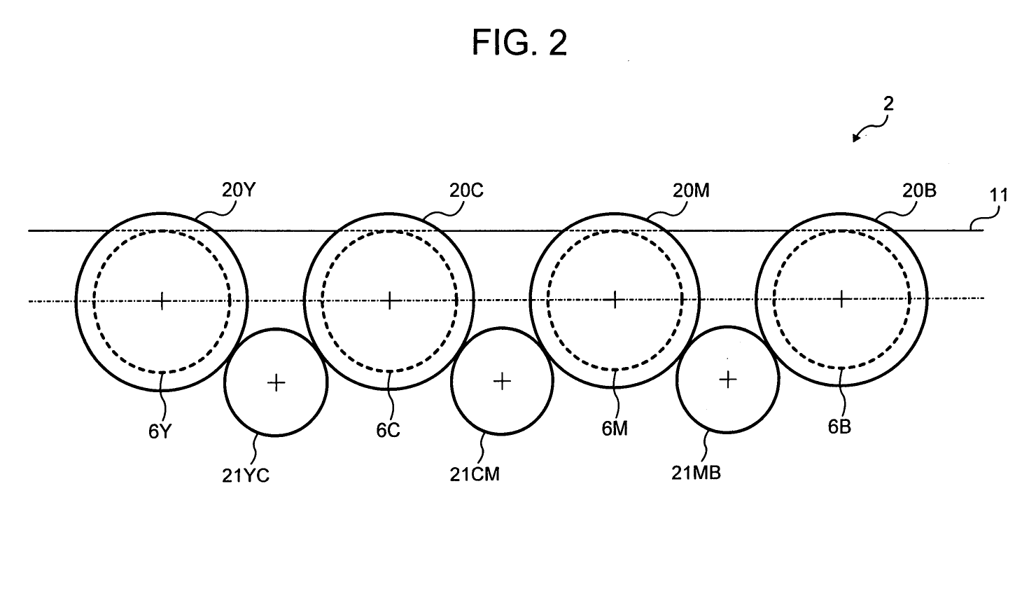

In FIG. 2, engagement of drum gears 20Y, 20C, 20M, and 20B via idle gears 21YC, 21CM, and 21MB is shown. The drum gears 20Y, 20C, 20M, and 20B are provided to the photosensitive drums 6Y, 6C, 6M, and 6B, respectively.

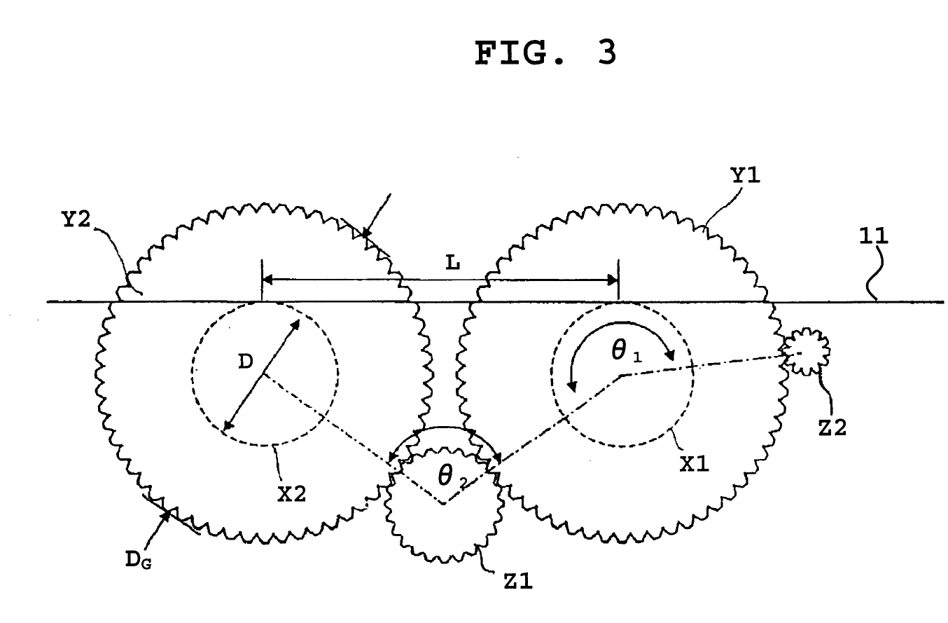

Referring to FIG. 3, further details of drum gear engagement applied in the color laser printer 1 are explained. In FIG. 3, reference symbols X1 and X2 denote two example photosensitive drums in contact with the intermediate transfer belt 11. These example photosensitive drums X1 and X2 are provided with drum gears Y1 and Y2, respectively, which are engaged with each other via an idle gear Z1. Also, a reference symbol Z2 denote a motor gear for transmitting rotation power from a motor (not shown) to drive the drum gear Y1. Accordingly, when the drum gear Y1 is driven by the motor gear Z2, the photosensitive drum X1 fixed to the drum gear Y1 is rotated and consequently the photosensitive drum X2 is rotated through transmission of rotation power from the drum gear Y1 via the idle gear Z1 and the drum gear Y2. The structure of gears illustrated in FIG. 3 is one simplified example to explain the principle of power transmission in the idle gear driving method. In other words, this principle of power transmission is applied to the structure of the tandem four photosensitive drums.

Therefore, the set of the photosensitive drums X1 and X2, the drum gears Y1 and Y2, and the idle gear Z1 of FIG. 3 can be a first set of the photosensitive drums 6Y and 6C, the drum gears 20Y and 20C, and the idle gear 21YC, or a second set of the photosensitive drums 6C and 6M, the drum gears 20C and 20M, and the idle gear 21CM, or the photosensitive drums 6M and 6B, the drum gears 20M and 20B, and the idle gear 21MB, shown in FIG. 2. In addition, a direction of power transmission can be altered by changing the position of the motor gear Z2. That is, the motor gear Z2 disposed to a position engaged with the drum gear Y1 can alternatively be disposed to another position to engage with the drum gear Y2.

In FIG. 3, reference symbol L denotes a station pitch referred to a distance between the pitch circle centers of the photosensitive drums X1 and X2. Reference symbol D denotes a diameter of the photosensitive drum X2. Reference symbol DG denotes a diameter of the pitch circle of the drum gear Y1. Reference symbol θ₁ denotes a first pinching angle and reference symbol θ₂ denotes a second pinching angle. The first pinching angle stands for an angle pinching the drum gear Y1 with the motor gear Z2 and the idle gear Z1. Similarly, the second pinching angle stands for an angle pinching the idle gear Z1 with the drum gears Y1 and Y2. These terms are explained below.

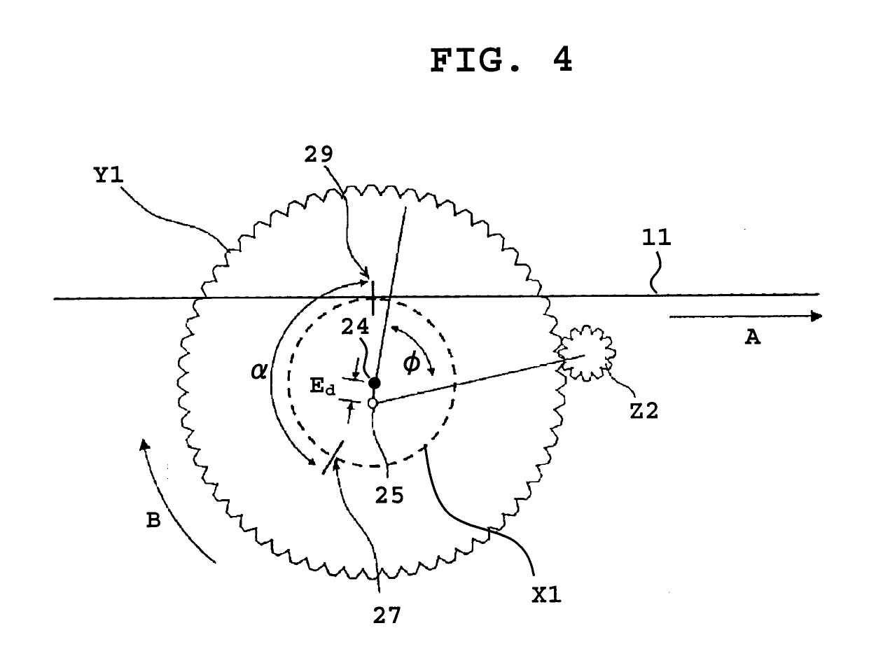

Next, principles of potential problems caused due to eccentricity of the drum gears are explained with reference to FIG. 4. Typical problems involved in the idle gear driving method are such as periodic position displacement and displacement among Y, M, C, and B color images. FIG. 4 illustrates the structure of the photosensitive drum X1, the drum gear Y1, and the motor gear Z2, which refer to a single reduction gear structure.

In FIG. 4, reference numeral 24 denotes a center of a pitch circle of the drum gear Y1, reference numeral 25 denotes a common rotation axis of the drum gear Y1 and the photosensitive drum X1. Also, reference numeral 27 denotes a write point where an image is written to the photosensitive drum X1, and reference numeral 29 denotes a transfer point where the primary transfer is conducted to transfer a toner image from the photosensitive drum X1 to the intermediate transfer belt 11.

A degree of eccentricity of the structure shown in FIG. 4 is extremely exaggerated with a multiplication of an actual value by a factor of a few hundreds, for the purposes of illustration. With such a difference, however, the component parts of FIG. 4 remain labeled with the same reference symbols and numerals as those of FIG. 1, for the sake of simplicity.

In the structure of FIG. 4, the photosensitive drum X1 and the drum gear Y1 are driven by the motor gear Z2 to rotate in a direction indicated by an arrow B with eccentricity. Such an eccentricity has an eccentric amount E_{d} that is expressed by a distance between the pitch center 24 and the rotation axis 25. This eccentricity has an eccentric direction from the rotation axis 25 towards the pitch center 24, and also has an eccentric angle φ relative to a reference line between the rotation axis 25 and a point of engagement between the drum gear Y1 and the motor gear Z2. In addition, an angle between the write point 27 and the primary transfer point 29 relative to the rotation axis 25 is referred to a write-to-transfer angle α.

If the motor gear Z2 has eccentricity, this eccentricity causes variations in angular velocity of the drum gear Y1 which may become an ultimate cause of the problems such as periodic position displacement and displacement among Y, M, C, and B color images. In this situation, however, there is a condition in that the motor gear Z2 is driven at a rotation cycle and such rotation cycle is an integral submultiple of a rotationally moving time period from the write point 27 to the primary transfer point 29. When this condition is satisfied, it is obvious that variations in angular velocity of the drum gear Y2 due to the eccentricity of the motor gear Z2 cannot become a cause of the above-mentioned position and color displacement problems. Therefore, in this case, the eccentricity of the motor gear Z2 can be disregarded and the eccentricity of the drum gear Y1 is determined as a real cause of the position and color displacement problems due to the angular velocity variations.

In addition, if the photosensitive drum X1 itself has eccentricity, it can also be disregarded as far as the displacement problems associated with the toner image are caused due to a phenomena called a slip transfer in which an image is transferred while the image is being slipped, known as a typical phenomenon in the electrophotographic system such as the laser printer, for example.

Under the conditions and the circumstances as described above, an amplitude A_{g} of the position displacement due to the eccentricity of the drum gear Y1 is expressed by a relationship:
A_{g}≈E_{d}(R_{D}/R_{d})|sin(α/2)|,
wherein E_{d} is the eccentric amount, R_{d} is an average radius of pitch circle of the drum gear Y1, R_{D} is a radius of the photosensitive drum X1, and α is the write-to-transfer angle between the write point 27 and the primary transfer point 29 relative to the rotation axis 25.

Next, phases of the positional displacement are explained with reference to FIG. 5. FIG. 5 demonstrates a case in which the eccentric direction is on the reference line between the rotation axis 25 and a point of engagement between the drum gear Y1 and the motor gear Z2, that is, the eccentric angle φ is 0. Under this situation, there is a point on the photosensitive drum X1 where a dot pitch becomes minimal and which is referred to a minimal dot pitch point 30 indicated by a white reference reverse-triangle mark in FIG. 5. This minimal dot pitch point 30 on the photosensitive drum X1 is at a center between the primary transfer point 29 and a point 28 π radian away from the write start point 25. Also, there is a point on the photosensitive drum X1 where the positional displacement in the reverse direction to the rotation direction becomes maximal and which is referred to a maximal positional displacement point 31 indicated by a black reference reverse-triangle mark in FIG. 5. This maximal positional displacement point 31 is π/2 radian away from the minimal dot pitch point 30 in the reverse direction to the rotation direction. When the minimal dot pitch point 30 passes by the primary transfer point 29, the toner image with a minimal dot pitch is transferred to the intermediate transfer belt 11. Similarly, when the maximal positional displacement point 31 passes by the primary transfer point 29, the toner image having a maximal positional displacement in the reverse direction to the rotation direction on the intermediate transfer belt 11.

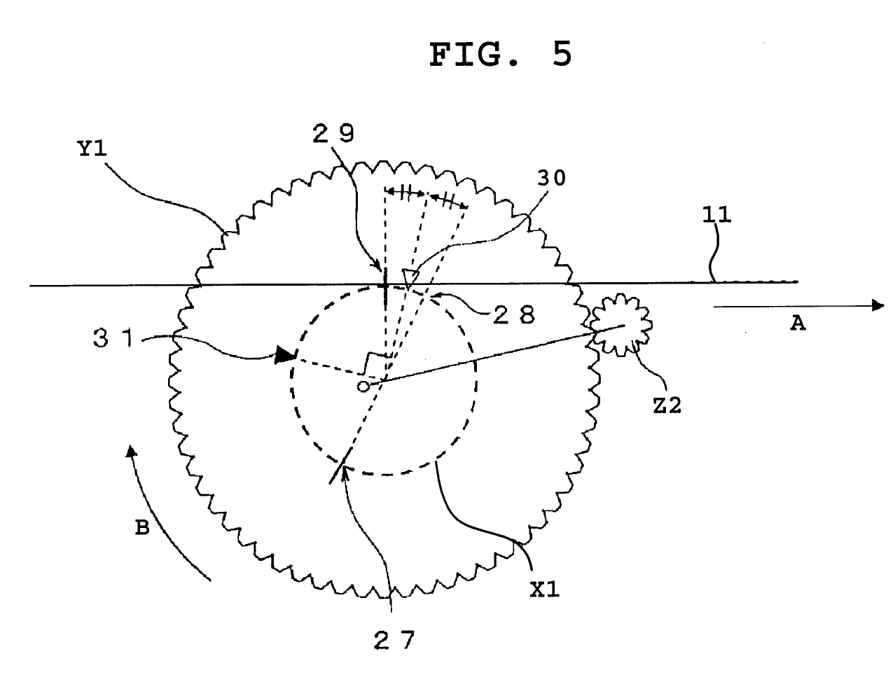

Next, a color displacement in a case where two photosensitive drums are driven by a single reduction gear system is explained with reference to FIG. 6. The structure of FIG. 6 is similar to the structure of FIG. 3, except for a way of engaging the photosensitive drums X1 and X2. That is, in this structure of FIG. 6, the photosensitive drums X1 and X2 are engaged with the motor gear Z2 without using the idle gear Z1. The photosensitive drum X1 has a write-to-transfer angle α1 and the photosensitive drum X2 has a write-to-transfer angle α2 which is equal to the write-to-transfer angle α1. In addition, the intermediate transfer belt 11 is moved at a linear speed which is supposed to be substantially equal to linear speeds of the photosensitive drums X1 and X2. It should be noted that these conditions are satisfied in most of the image forming apparatuses.

Under these conditions, it is possible that the photosensitive drums X1 and X2 are disposed such that a station pitch L between the pitch circle centers of the photosensitive drums X1 and X2 is made equal to each of circumferences of the photosensitive drums X1 and X2. It is also possible that an eccentric angle φ1 of the photosensitive drum X1 is equal to an eccentric angle φ2 of the photosensitive drum X2. When the eccentric angles φ1 and φ2 are equal to each other, the phases of the color displacement by the photosensitive drums X1 and X2 caused on the intermediate transfer belt 11 are in agreement with each other. As a result, the color displacement becomes minimal. In addition to it, the color displacement can be made even smaller by presetting the eccentric amounts of the drum gears Y1 and Y2 equal to each other.

In other words, to minimize the color displacement in the above-described situation, an optimal eccentric-phase difference Φ2 of the eccentric angles φ1 and φ2 needs to be 0 and an optimal rate of eccentric amounts Ed1 and Ed2 needs to be 1. When these conditions are satisfied, the color displacement becomes 0 even with the eccentricities of the drum gears Y1 and Y2.

On the other hand, it is also possible that the photosensitive drums X1 and X2 are disposed such that a station pitch L between the pitch circle centers of the photosensitive drums X1 and X2 is made not equal to each of circumferences of the photosensitive drums X1 and X2. In this case, a difference between the station pitch L and one of circumferences of the photosensitive drums X1 and X2 needs to be converted into a value of angle. Such an angle represents an optimal eccentric-phase difference Φ2 between the eccentric angles φ1 and φ2, which is expressed, especially when the eccentric angle φ1 is 0, by an equation:
Φ₂=φ2=2(L−πD)/D,
Wherein Φ2 is the optimal eccentric-phase difference between the eccentric angles φ1 and φ2, D is a diameter of the photosensitive drums X1 and X2, and L is the station pitch between the pitch circle centers of the photosensitive drums X1 and X2.

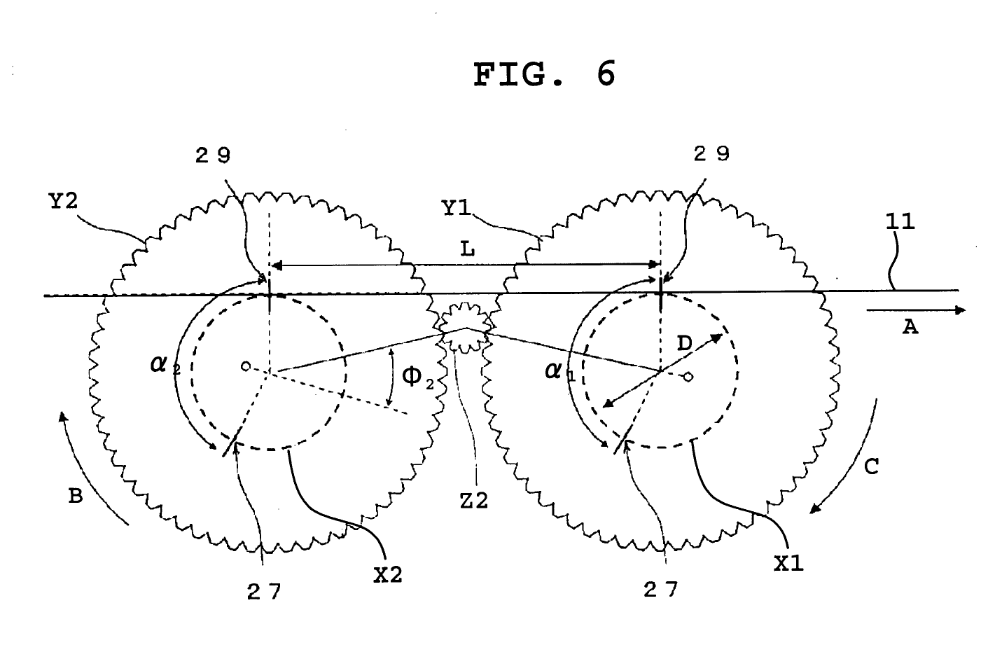

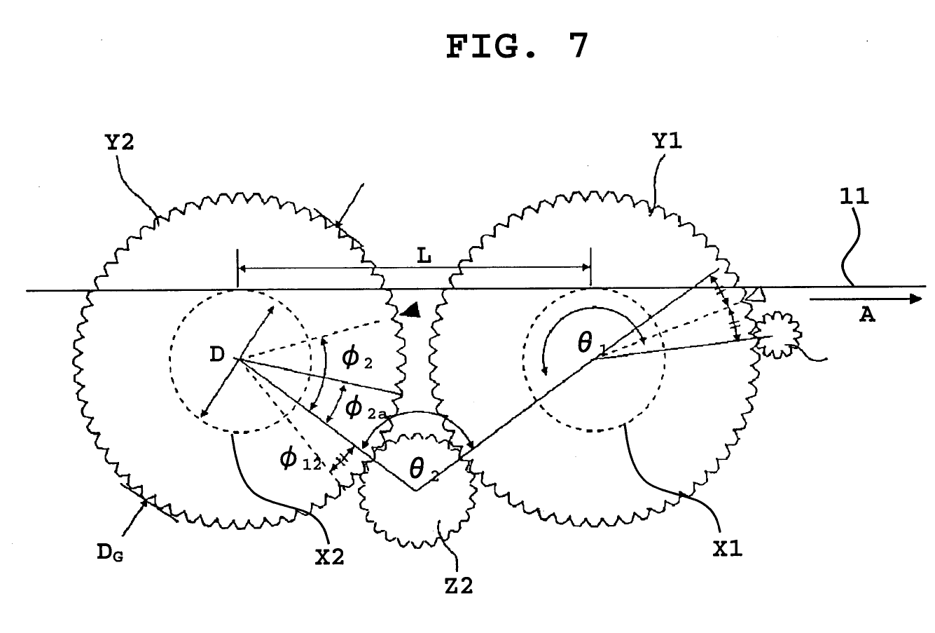

Next, the positional displacement and the color displacement in the structure of FIG. 3 are described with reference to FIG. 7 which illustrates the same structure as FIG. 3. In FIG. 7, when the drum gear Y2 is rotated by the rotation of the idle gear Z1, the drum gear Y2 generates variations in rotation velocity and such variations mainly includes variation elements caused due to eccentricity of the drum gear Y2 itself and due to the eccentricity of the drum gear Y1.

The drum gears Y1 and Y2 themselves have substantially the same eccentricity and the same variation element in rotation velocity. The eccentricity that the drum gear Y1 has is defined as a first eccentricity, and the eccentricity that the drum gear Y2 itself has is defined as a second eccentricity. In addition, the eccentricity that the drum gear Y2 would receive from the drum gear Y1 via the idle gear Z1 is defined as a transmissive eccentricity. Such a transmissive eccentricity is sought in the following manner with reference to FIG. 7.

In FIG. 7, the drum gear Y1 has two gear-engaged points with the motor gear Z2 and the idle gear Z1. At each of the two gear-engaged points, a velocity variation occurs due to the first eccentricity, having a frequency of a sine wave having a period of one rotation of the drum gear Y1. The sine-wave velocity variations at both the two gear-engaged points are shifted from each other by a phase of (θ1+π). The velocity variation transmitted to the drum gear Y2 via the idle gear Z1 is a sum total of both the sine waves, and has an amplitude equal to an amplitude of a velocity variation caused due to an eccentric amplitude A₁₂ of the transmissive eccentricity through the single reduction gear system. The eccentric amplitude A₁₂ is expressed by an equation:
A₁₂=√( (|A₁|+|A₁|cos(θ₁+π) )²+(|A₁|+|A₁|sin(θ₁+π) )²),
wherein A₁ is an eccentric amplitude of the first eccentricity of the drum gear Y1, A₁₂ is the eccentric amplitude of the transmissive eccentricity of the drum gear Y2, and θ₁ is the first pinching angle of the drum gear Y1.

When the eccentric amplitude A₁ of the first eccentricity of the drum gear Y1 is 1, the above formula of the eccentric amplitude A₁₂ of the transmissive eccentricity is expressed as:
A₁₂=√( (1+cos(θ₁+π) )²+(1+sin(θ₁+π) )²).

Directions of the first and transmissive eccentricities are arranged such that the first eccentricity has a direction towards a white reference reverse-triangle mark and the transmissive eccentricity has a direction towards the idle gear Z1. Therefore, a phase difference φ₁₂ between the first eccentricity and the transmissive eccentricity is expressed by an equation:
φ₁₂=(θ₁−π)/2.

The drum gear Y2 generates a velocity variation caused due to the second eccentricity of the drum gear Y2 itself by itself, while it receives the velocity variation caused due to the transmissive eccentricity from the drum gear Y1 via the idle gear Z1, as described above. That is, the drum gear Y2 appears to generate a total sum of the above-mentioned two different velocity variations, which is referred to as a total velocity variation. Such total velocity variation of the drum gear Y2 can be converted into a velocity variation caused due to an imaginary eccentricity of the drum gear Y2. The imaginary eccentricity of the drum gear Y2 has an eccentric amplitude A₂ₐ and an eccentric angle φ₂ₐ, which are expressed by equations:
A₂ₐ=√( (A₁₂ cos φ₁₂+A₂ cos φ₂)²+(A₁₂ sin φ₁₂+A₂ sin φ₂)²), and
φ₂ₐ=tan⁻¹( (A₁₂ sin φ₁₂+A₂ sin φ₂)/(A₁₂ cos φ₁₂+A₂ cos φ₂)
wherein A₂ is an eccentric amplitude of the second eccentricity of the drum gear Y2, A₁₂ is the eccentric amplitude of the transmissive eccentricity transmitted from the drum gear Y2, φ₂ is the eccentric angle of the photosensitive drum X2, and φ₁₂ is the phase difference between the first eccentricity and the transmissive eccentricity.

The color displacement occurring between the drum gears Y1 and Y2 in FIG. 7 can be examined in a manner similar to that occurring in the single reduction gear system of FIG. 6. That is, when an orientation of the drum gear is preset in such a way that the phase φ₂ₐ of the imaginary eccentricity of the drum gear Y2 becomes the optimal eccentric-phase difference Φ₂ between the eccentric angles φ1 and φ2, the color displacement due to the second eccentricity of the drum gear Y2 is minimal. In this case, since the optical eccentric amplitude rate is 1, the amplitude of the color displacement is 0 when the eccentric amplitude A₂ₐ of the imaginary eccentricity of the drum gear Y2 is equal to the eccentric amplitude A1 of the first eccentricity of the drum gear Y1.

Therefore, an eccentric amplitude A_{2BEST} of the second eccentricity of the drum gear Y2 is sought, which is needed to equalize the eccentric amplitude A₂ₐ of the imaginary eccentricity of the drum gear Y2 with the eccentric amplitude A₁ of the first eccentricity of the drum gear Y1. Also, an eccentric angle φ_{2BEST} of the second eccentricity of the drum gear Y2 is sought, which is needed to equalize the phase φ₂ₐ of the imaginary eccentricity of the drum gear Y2 with the optimal eccentric-phase difference Φ₂ between the eccentric angles φ₁ and φ₂. Such eccentric angle A_{2BEST} of the second eccentricity of the drum gear Y2 and the eccentric amplitude φ_{2BEST} of the second eccentricity of the drum gear Y2 can be obtained basically by seeking a difference between the transmissive eccentricity and the imaginary eccentricity, and are expressed by the following equations:
A_{2BEST}=√( (A₁ cos Φ₂−A₁₂ cos φ₁₂)²+(A₁ sin Φ₂−A₁₂ sin φ₁₂) )²), and
φ_{2BEST}=tan⁻¹( (A₁ sin Φ₂−A₁₂ sin φ₂)/(A₁ cos Φ₂−A₁₂ cos φ_{12) ).}

When the eccentric amplitude A_{2BEST} and the eccentric angle φ_{2BEST} are thus obtained and the drum gear Y2 is adjusted to have these factors as close as possible, it becomes possible to reduce the color displacement due to the eccentricity of the drum gears Y1 and Y2 to a value substantially close to 0. In addition, the optimal eccentric amplitude rate A_{R} (i.e. A₂/A₁) can be obtained by substituting 1 for A₁ in the above equations.

When the eccentric amplitude A₁ of the first eccentricity of the drum gear Y1 is 1, the eccentric angle A_{2BEST} of the second eccentricity of the drum gear Y2 is expressed as:
A_{2BEST}=√( (cos Φ₂−A₁₂ cos φ₁₂)²+(sin Φ₂−A₁₂ sin φ₁₂)²)

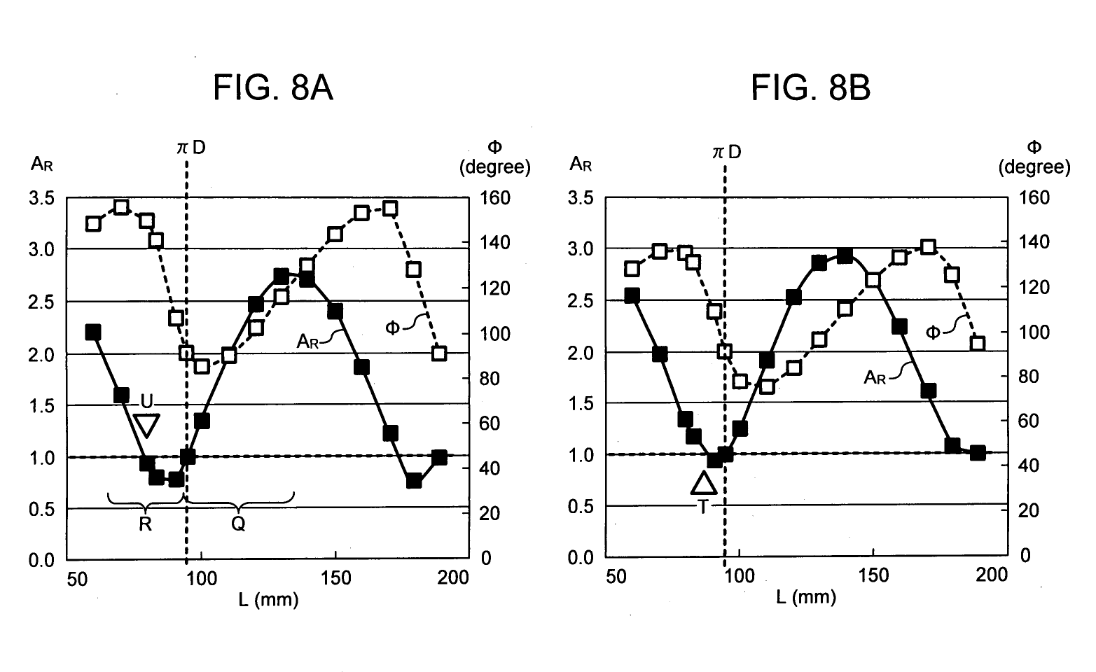

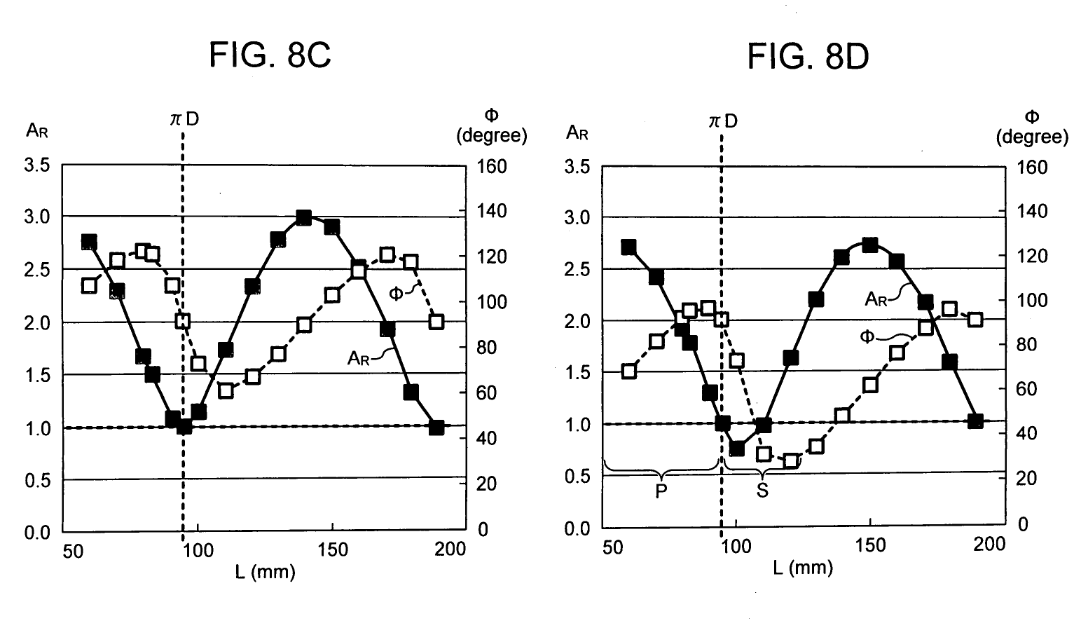

As described above, it is understood that an optimal eccentric amplitude for reducing the color displacement to 0 can be sought with respect to an optimal eccentric-phase difference. Based on that understanding, the optimal eccentric-phase difference and the optimal eccentric amplitude rate were plotted in variety of ways, as indicated in FIGS. 8A-8D, to see changes of these factors in relation to station pitch L between two adjacent stations or drum gears. As a result, obvious relationships were found among the conditions of the color laser printer 1 and the optimal eccentric-phase difference and the optimal eccentric amplitude rate. Consequently, several apparent tendencies were recognized as indicated in the following example experiments.

FIGS. 8A-8D are graphs for explaining the results of an example experiment in connection with the embodiment of the present invention. These graphs are made by plotting the resultant optimal eccentric-phase differences Φ and the optimal eccentric amplitude rates A_{R} which were found to reduce the color displacement to 0 at each of experimentally varied station pitches L. A basic graph is shown in FIG. 8B, in which the conditions of the color laser printer 1 are arranged as follows. That is, the diameter D of the photosensitive drums X1 and X2 (i.e., the photosensitive drum 6 of FIG. 1) is 30.06 mm, the station pitch L is 82.5 mm, the diameter D_{G} of the drum gears Y1 and Y2 is 79.895 mm, the first pinching angle θ₁ is 210.07 degrees, and the second pinching angle θ₂ is 91.79 degrees.

It should be noted that the first pinching angle θ₁ refers to an angle pinching around the rotation axis of the photosensitive drum X1 from above, as shown in FIG. 3. Also, the intermediate transfer belt 11 is in contact with the photosensitive drum X1 at an uppermost portion of the photosensitive drum X1 relative to the rotation axis thereof, as shown in FIG. 3. Therefore, the first pinching angle θ₁ is greater than π. If the structure is changed such that the intermediate transfer belt 11 is arranged in contact with the photosensitive drum X1 at a lowermost portion of the photosensitive drum X1 relative to the rotation axis thereof, the first pinching angle θ₁ can be changed as smaller than π. When the first pinching angle θ₁ of 210.07 degrees, demonstrated in FIG. 8B, is applied to the structure of FIG. 3, the first pinching angle θ₁ greater than π. Accordingly, it is understood that the intermediate transfer belt 11 is in contact with the photosensitive drum X1 at an uppermost portion of the photosensitive drum X1. Also, it should be noted that the second pinching angle θ₂ commonly refers to a narrower angle pinching around the rotation axis of the idle gear Z1, regardless of the position of the intermediate transfer belt 11.

Under the conditions set forth above, the optimal eccentric-phase difference of 132.18 degrees and the optimal eccentric amplitude rate of 1.1835 are obtained by simulations. These figures mean that the color displacement due to the eccentricity of the pitch circle of the drum gears Y1 and Y2 becomes substantially 0 when the eccentric phase of the pitch circle of the drum gear Y1 is set with 132.18 degrees in a counterclockwise direction relative to the eccentric phase of the pitch circle of the drum gear Y2 and when the eccentric amplitude of the pitch circle of the drum gear Y1 is set to a value 1.1835 times greater than the eccentric phase of the pitch circle of the drum gear Y2.

As a special case, it was found that the color displacement having an amplitude of approximately 13% or more of the eccentric amplitude inevitably occurred when the eccentric amplitude rate is set to 1, that is, the eccentric amplitudes of the drum gears Y1 and Y2 are equivalent to each other. This happened even with the optimal eccentric phase.

Thus, the optimal eccentric-phase difference and the optimal eccentric amplitude rate were sought and plotted for each one of the experimentally varied station pitches L, so that the graph of FIG. 8A was drawn. At this time, there was a risk that the positions of the drum gear axes were changed and accordingly the layout of the drum gears were disordered when the station pitch L was varied. However, this problem was resolved by supposing that the diameters of the entire drum gears were made in proportion to the station pitch L.

The graphs of FIGS. 8A, 8C, and 8D were obtained through similar procedures by changing the position of the motor gear Z2 (i.e., changing the first pinching angle θ₁), seeking the optimal eccentric-phase difference and the optimal eccentric amplitude rate, and plotting them for each one of the experimentally varied station pitches L. Table 1 below indicates the first pinching angles θ₁ applied in the experiment represented in the graphs of FIGS. 8A-8D.

TABLE 1

| | | | | |
|---|---|---|---|---|
| θ₁ (degree) | 238.14 | 210.07 | 180 | 80 |

Based on the graphs of FIGS. 8A-8D, several important facts were found. For example, throughout the graphs of FIGS. 8A-8D, the optimal eccentric-phase difference Φ is equal to the second pinching angle θ₂ and the optimal eccentric amplitude rate A_{R} is 1 under the condition that the station pitch L is equal to a value of a multiplication of the circumference πD of the photosensitive drums X1 and X2 by a factor of a positive integer n (i.e., L=πD*n).

Another fact found is that, as shown in FIG. 8C, the optimal eccentric amplitude rate is always equal to or greater than 1 when the first pinching angle θ₁ is equal to π (i.e., 180 degrees). On the other hand, as shown in FIGS. 8A, 8B, and 8D, there is an area in which the optimal eccentric amplitude rate is equal to or smaller than 1 along a horizontal axis of the graphs in the vicinity of a position where the station pitch L is equal to a value of a multiplication of the circumference πD of the photosensitive drums X1 and X2 by a factor of a positive integer n (i.e., L=πD*n), when the first pinching angle θ₁ is not equal to π. This area exists in either area where the station pitch L is smaller or greater than a value of a multiplication of the circumference πD of the photosensitive drums X1 and X2 by a factor of a positive integer n. This choice depends on a value of the first pinching angle θ₁.

Furthermore, when the first pinching angle θ₁ is greater than π, the above-described area where the optimal eccentric amplitude rate is equal to or smaller than 1 exists in a side along the horizontal axis of the graphs in which the station pitch L is smaller than a value of a multiplication of the circumference πD of the photosensitive drums X1 and X2 by a factor of a positive integer n (i.e., L<πD*n). When the first pinching angle θ₁ is smaller than π, the above-described area where the optimal eccentric amplitude rate is equal to or smaller than 1 exists in a side along the horizontal axis of the graphs in which the station pitch L is greater than a value of a multiplication of the circumference πD of the photosensitive drums X1 and X2 by a factor of a positive integer n (i.e., L>πD*n). In addition, the area where the optimal eccentric amplitude rate is equal to or smaller than 1 has a horizontal width which is narrowed as the first pinching angle θ₁ becomes close to π (i.e., 180 degrees).

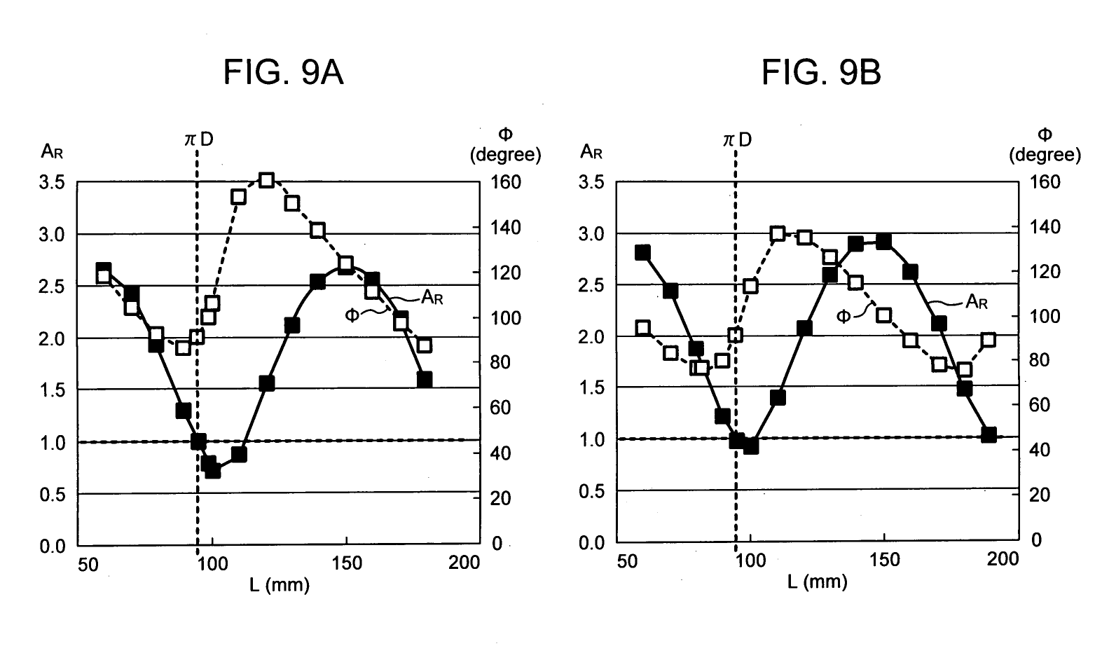

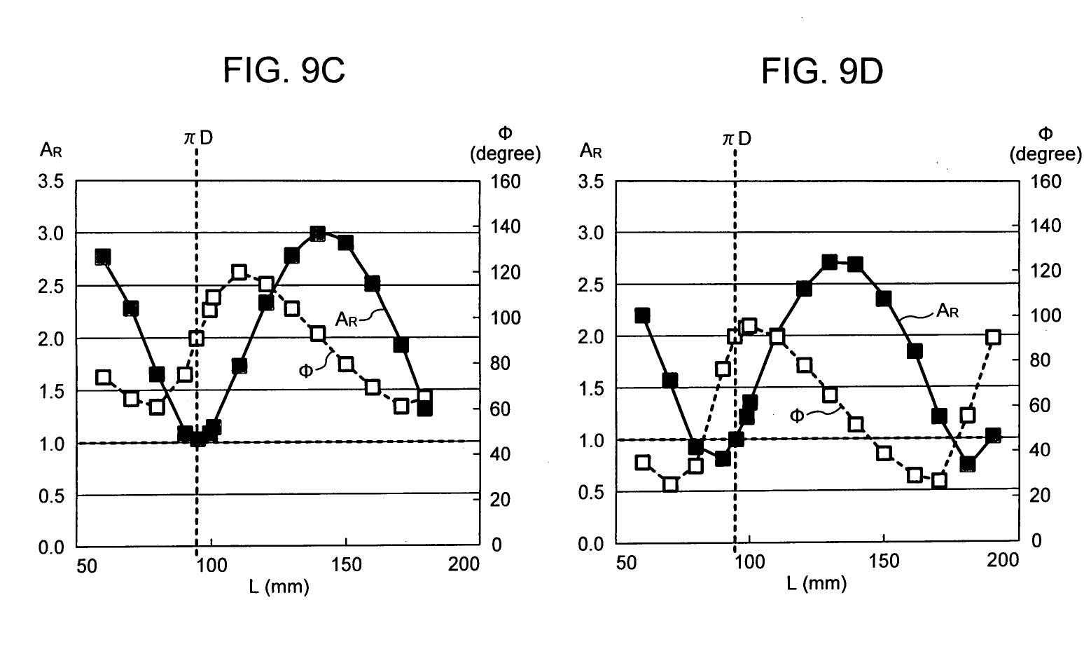

FIGS. 9A-9D demonstrate the results of another example experiment. In this experiment, the color laser printer 1 had a different structure. That is, the intermediate transfer belt 11 is arranged under the photosensitive drums, instead of being above the photosensitive drums as shown in FIG. 2. The experiment was conducted on the color laser printer 1 with such a structure. Then, in a similar manner as that of the graphs of FIGS. 8A-8D, the experiment results were plotted. The experiment conditions were almost same as those of FIG. 8B, except for the above-mentioned positional difference of the intermediate transfer belt 11 and accordingly the first pinching angle θ₁ to which values different from those shown in Table 1 are assigned, as shown in Table 2 below.

TABLE 2

| | | | | |
|---|---|---|---|---|
| θ₁ (degree) | 113.27 | 149.93 | 180 | 240 |

By analyzing the graphs of FIGS. 9A-9D, it is obvious that there is no contradictions between the above-described facts found from the graphs of FIGS. 8A-8D and those from the graphs of FIGS. 9A-9D.

Based on the results of the above two experiments, the following five conclusions are obtained.

First, in the idle gear driving method, there is an optimal eccentric amplitude rate as well as an optimal eccentric-phase difference in accordance with design values of the rotationally moving mechanism and a relationship between the station pitch and a circumference length of the photosensitive drum. Therefore, it is possible to reduce the color displacement caused due to the eccentricities of the drum gears Y1 and Y2 by adjusting the eccentric amplitude rate A₂/A₁ in accordance with the station pitch and by adjusting the eccentric-phase difference, between the eccentric amplitude A₁ of the pitch circle of the drum gear Y1 and the eccentric amplitude A₂ of the pitch circle of the drum gear Y2.

Second, the optimal eccentric amplitude rate A₂/A₁ is invariably greater than 1 under the conditions of L≠πD*n and θ₁=π, as described above. It is preferable to use the drum gear Y2 having the eccentric amplitude A₂ greater than the eccentric amplitude A₁ of the drum gear Y1 so as to achieve the optimal eccentric amplitude rate A₂/A₁.

Third, the optimal eccentric amplitude rate A₂/A₁ is also invariably greater than 1 under the conditions of L<πD*n and θ₁<π, as shown in an area P of FIG. 8D. It is preferable to use the drum gear Y2 having the eccentric amplitude A₂ greater than the eccentric amplitude A₁ of the drum gear Y1 so as to achieve the optimal eccentric amplitude rate A₂/A₁.

Fourth, the optimal eccentric amplitude rate A₂/A₁ is also invariably greater than 1 under the conditions of L>πD*n and θ₁>π, as shown in an area Q of FIG. 8A. It is preferable to use the drum gear Y2 having the eccentric amplitude A₂ greater than the eccentric amplitude A₁ of the drum gear Y1 so as to achieve the optimal eccentric amplitude rate A₂/A₁.

Fifth, the conditions of L<πD*n and θ₁>π are met in an area R of FIG. 8A, and the conditions of L>πD*n and θ₁<π are met in an area S of FIG. 8D. These area R of FIG. 8A and area S of FIG. 8D contains conditions that the optimal eccentric amplitude rate A₂/A₁ becomes equal to 1, although the station pitch L is out of the condition L=πD*n. These cases are therefore capable of reducing the color displacement more than the method of the above second, third, and fourth conclusions, especially when no adjustment is made on the eccentric amplitude of the drum gears.

Preferably, design values need to be selected so that the eccentric amplitude rate is 1. Accordingly, in FIG. 8B, for example, a preferable value of the station pitch is about 87 mm, as indicated by a white reference triangle T. Also, when the first pinching angle θ1 is changed to 238.14 degrees from the base conditions of FIG. 8B, a preferable value of the station pitch is about 82 mm, as indicated by a white reference reverse triangle U.

There are two possible ways to optionally select a suitable optimal eccentric amplitude rate A₂/A₁. In one way, firstly, gears in a gear unit are subjected to measurements of eccentricities of the pitch circles and are sorted by the amount of eccentricity. Then, gears are selected to be used for the drum gears Y1 and Y2 in accordance with the amount of eccentricity during an assembling process. The gear unit here means a unit in which gears are attached to its rotational shafts or a unit in which rotational shafts of the gears are attached to its bearings. The pitch circle eccentricity of a gear may be changed when the gear is attached to the rotational shaft of the unit or when the rotational shaft of the gear is attached to the bearings of the unit. Therefore, in such a case, it is needed to measure the pitch circle eccentricity as a whole of the gear unit, not as a single gear.

In another way, two kinds of gears having different eccentricities are manufactured and are selected to be used for the drum gears Y1 and Y2 in accordance with their eccentric amounts during an assembling process. This method is effective, especially, when variation of eccentricity is relatively small and in a case there is no substantial change in the pitch circle eccentricity when the gears are attached to the rotational shafts or to the bearings.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

This patent specification is based on Japanese patent applications, No. 2004-239140 filed on Aug. 19, 2004 and No. 2005-173175 filed on Jun. 14, 2005, in the Japan Patent Office, the entire contents of each of which are incorporated by reference herein.

What is claimed is:

1. An image forming apparatus, comprising:
a transfer belt;
a first image carrying drum arranged in contact with the transfer belt;
a second image carrying drum having dimensions in substantially common with the first image carrying drum and arranged in contact with the transfer belt;
a first drum gear attached to the first image carrying drum;
a second drum gear having dimensions in substantially common with the first image carrying drum and attached to the second image carrying drum;
a motor gear configured to rotate the first drum gear; and
an idle gear configured to transmit a driving power from the first drum gear to the second drum gear,
wherein a station pitch between rotation axes of the first and second drum gears is different from a value of a multiplication of a circumference of the first and second image carrying drums by a factor of an arbitrary positive integer, and
wherein an eccentric amplitude rate between a first eccentric amplitude that a pitch circle of the first drum gear has and a second eccentric amplitude that a pitch circle of the second drum gear has is optionally selected, during a process of assembling to the apparatus, in accordance with factors including the station pitch, a design value of the circumference of the first and second image carrying drums, and a design value of the idle gear to satisfy a plurality of predetermined conditions.

2. The image forming apparatus according to claim 1, wherein the plurality of predetermined conditions include equalities:
A_{2BEST}=·( (cos Φ₂−A₁₂ cos φ₁₂)²+(sin Φ₂−A₁₂ sin φ₁₂)²)
A₁₂=√( (1+cos(θ₁+π) )²+(1+sin(θ₁+π) )²)
φ₁₂=(θ₁−π)/2; and
Φ₂=2 (L−πD)/D
wherein A_{2BEST} is an eccentric angle of eccentricity of the second drum gear, A₁₂ is an eccentric amplitude of a transmissive eccentricity of the second drum gear, θ₁ is a first pinching angle of the second drum gear, φ₁₂ is an eccentric-phase difference between an eccentricity of the first drum gear and the transmissive eccentricity, Φ₂ is an optimal eccentric-phase difference between the eccentric angles of the first and second drum gears, L is the station pitch, and D is the diameter of the first and second image carrying drums.

3. The image forming apparatus according to claim 1, wherein the eccentric amplitude that the second pitch circle of the second drum gear has is greater than the eccentric amplitude that the first pitch circle of the first drum gear has when a first pinching angle for pinching the first drum gear with the motor gear and the idle gear is substantially equal to 180 degrees.

4. The image forming apparatus according to claim 1, wherein the eccentric amplitude that the second pitch circle of the second drum gear has is greater than the eccentric amplitude that the first pitch circle of the first drum gear has when a first pinching angle for pinching the first drum gear with the motor gear and the idle gear is smaller than 180 degrees and when the station pitch between rotation axes of the first and second drum gears satisfies an inequality:
πD* (n−0.5)<L<πD*n,
wherein π is 180 degree, n is a natural number, L is the station pitch, and D is the diameter of the first and second image carrying drums.

5. The image forming apparatus according to claim 1, wherein the eccentric amplitude that the second pitch circle of the second drum gear has is greater than the eccentric amplitude that the first pitch circle of the first drum gear has when a first pinching angle for pinching the first drum gear with the motor gear and the idle gear is greater than 180 degrees and when the station pitch between rotation axes of the first and second drum gears satisfies an inequality:
πD*n<L<πD*(n−0.5),
wherein π is 180 degree, n is a natural number, L is the station pitch, and D is the diameter of the first and second image carrying drums.

6. An image forming apparatus, comprising:
a transfer belt;
a first image carrying drum arranged in contact with the transfer belt;
a second image carrying drum having dimensions in substantially common with the first image carrying drum and arranged in contact with the transfer belt and in line with the first image carrying drum;
a first drum gear attached to the first image carrying drum;
a second drum gear having dimensions in substantially common with the first image carrying drum and attached to the second image carrying drum;
a motor gear configured to rotate the first drum gear; and
an idle gear configured to transmit a driving power from the first drum gear to the second drum gear,
wherein a first pinching angle for pinching the first drum gear with the motor gear and the idle gear is greater than 180 degrees, and a station pitch between rotation axes of the first and second drum gears and a circumference of the first and second image carrying drums satisfy an inequality πD*(n−0.5)<L<πD*n, wherein π is 180 degree, n is a natural number, L is the station pitch, and D is the diameter of the first and second image carrying drums.

7. An image forming apparatus, comprising:
a transfer belt;
a first image carrying drum arranged in contact with the transfer belt;
a second image carrying drum having dimensions in substantially common with the first image carrying drum and arranged in contact with the transfer belt;
a first drum gear attached to the first image carrying drum;
a second drum gear having dimensions in substantially common with the first image carrying drum and attached to the second image carrying drum;
a motor gear configured to rotate the first drum gear; and
an idle gear configured to transmit a driving power from the first drum gear to the second drum gear,
wherein a first pinching angle for pinching the first drum gear with the motor gear and the idle gear is smaller than 180 degrees, and a station pitch between rotation axes of the first and second drum gears and a circumference of the first and second image carrying drums satisfy an inequality πD*n<L<πD*(n−0.5), wherein π is 180 degree, n is a natural number, L is the station pitch, and D is the diameter of the first and second image carrying drums.
